(19) United States
(12) Patent Application Publication
(10) Pub. No.: US 2026/0332470 A1
(43) Pub. Date: Oct. 22, 2026

(54) SYSTEM AND METHOD FOR MONITORING IT SERVICES AND PREVENTING DOWNSTREAM TICKET GENERATION IN IT SERVICE MANAGEMENT

(71) Applicant: The PNC Financial Services Group, Inc., Pittsburgh, PA (US)

(72) Inventors: Jason L. Miller, Chandler, AZ (US); Alba Bella, Staten Island, NY (US); Katrina Slivkoff, Aliso Viejo, CA (US)

(21) Appl. No.: 19/574,796

(22) Filed: Mar. 23, 2026

Related U.S. Application Data
(60) Provisional application No. 63/791,108, filed on Apr. 18, 2025.

(51) Int. Cl. H04L 41/0654

(52) U.S. Cl. CPC H04L 41/0654

(57) ABSTRACT

Systems and methods monitor IT services and preventing unnecessary IT Service Management (ITSM) ticket generation. This system employs computer-implemented methods to monitor IT-related services, such as application monitoring, log management, and change intelligence systems. By detecting issues within these services, the system prevents downstream applications from generating ITSM tickets for problems originating upstream. This proactive approach enhances resource allocation and system stability by reducing the volume of redundant tickets, thereby lowering operational costs.

### PRIORITY CLAIM

The present application claims priority to United States provisional application Serial No. 63/791,108, filed Apr. 18, 2025, titled “System and Method for Monitoring IT Services and Preventing Downstream Ticket Generation in IT Service Management.”

### BACKGROUND

IT Service Management (ITSM) is a set of strategies, policies, and procedures designed to ensure the efficient and effective delivery of IT services to an organization. At its core, ITSM aims to align IT services with the needs of the business. A crucial component of ITSM is ticket management. A ticket, in the context of IT, is a formal record of a request for IT support or a reported IT issue. This could range from a simple password reset to a complex network outage. When an IT user encounters a problem or needs assistance, they typically submit a ticket through a ticketing system. This ticket is then assigned to an appropriate IT support team. The team investigates the issue, categorizes it, and assigns it a priority level. They then work to resolve the issue and update the ticket status throughout the process. Once the issue is resolved, the ticket is closed.

Sometimes when an IT system or application experiences issues, it can lead to cascading problems throughout the organization, impacting various downstream processes and their users.

### SUMMARY

In one general aspect, the present invention is directed to systems and methods for monitoring IT-related services within an organization’s IT infrastructure to prevent unnecessary IT Service Management (ITSM) ticket generation. Embodiments of the present invention can focus on detecting issues with IT-related services and preventing downstream applications from issuing ITSM tickets when the problem originates from the IT service itself, rather than the downstream application. The system can include an application monitoring system, a log management system, and a change intelligence system, each equipped with agents that collect and write data to a database. These agents are monitored by engines that assess their operational status and compliance.

The engines execute scripts to perform tasks such as API calls and data collection, and they can operate on a periodic schedule determined by a task scheduling server. If an agent is found to be missing or inoperative, the engine can initiate a compliance check process, which includes verifying connectivity and health status. If the agent fails multiple serial compliance checks, an alert can be activated and an ITSM ticket issued. The system can also include a mechanism to block data flow from inoperative agents to prevent excessive ticket generation for downstream systems that consume data from the upstream agent. Once the agent becomes operative again, the data flow is restored.

Embodiments of the present invention can enhance the stability and efficiency of IT systems by reducing unnecessary ticketing and improving issue resolution processes. It can improve resource allocation by allowing IT departments to focus on genuine issues rather than redundant tickets, thereby reducing the workload on support teams. This efficiency leads to enhanced system stability, as the system can block faulty data from inoperative agents, preventing cascading failures in downstream systems. Additionally, embodiments of the invention can promote proactive issue management through its monitoring capabilities, enabling early detection and resolution of problems before they escalate. This approach minimizes downtime and maintains service quality. By focusing on actual issues, the system can also reduce operational costs associated with IT support and maintenance, translating into significant cost savings for organizations. Still further, the system can ensure improved data accuracy by blocking unreliable data from inoperative agents, thereby enhancing the overall quality and reliability of the IT environment.

Embodiments of the present invention can also provide a specific improvement to the functioning of computer-implemented IT operations systems. By automatically detecting inoperative upstream agents and interrupting the propagation of stale or incomplete data to downstream systems, the disclosed techniques prevent cascaded failures, reduce false incident generation, and stabilize distributed monitoring architectures. This improves system reliability and reduces processing load on downstream applications by ensuring that such applications operate only on valid data. The invention therefore enhances the performance of the underlying computer infrastructure itself, rather than merely automating a business practice.

These and other benefits that can be realized through various embodiments of the present invention will be apparent from the description that follows.

### FIGURES

Various embodiments of the present invention are described herein by way of example in connection with the following figures.

FIG. 1 is a diagram of an enterprise IT system, including an application monitoring system, a log management system, a change intelligence system, a ITSM system and an event management system.

FIG. 2 is a diagram of instances of engines, for performing scheduled jobs, distributed across a plurality of servers.

FIG. 3 is a diagram of a process, according to various embodiments of the present invention, performed by an engine when an agent is determined to be missing.

FIG. 4 is a diagram of system for blocking data flow from an agent when the agent is inoperative according to various embodiments of the present invention.

### DESCRIPTION

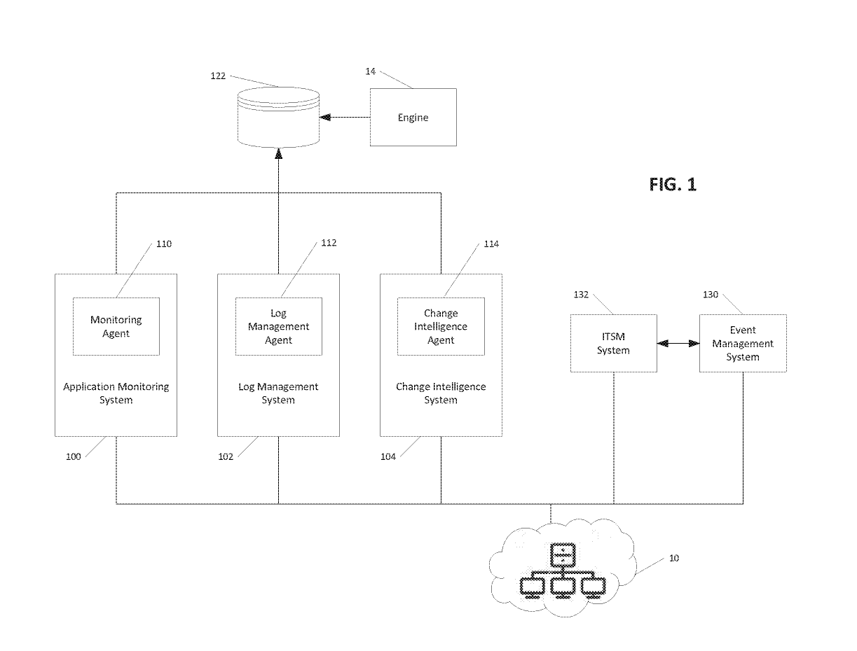

The present invention is directed, in various embodiments, to computer-implemented systems and methods for monitoring IT-related services of an organization’s IT system and, when an issue is detected with one (or more) of the IT-related services, preventing downstream applications of the affected IT-related service from issuing ITSM tickets because the issue is with the IT-related service, not the downstream application. FIG. 1 is a block diagram of the system according to various embodiments. The IT-related services that are monitored can include an application monitoring system 100, a log management system 102 and/or a change intelligence system 104. The application monitoring system 100 may be, for example, a comprehensive application performance management (APM) and infrastructure monitoring solution, such as, in one embodiment, Dynatrace, that provides end-to-end visibility into the health and performance of an organization’s IT environment 10, from the infrastructure to the application layer, for example. Such an application monitoring system 100 can, for example, use artificial intelligence (AI) to automatically detect and diagnose problems, allowing an organization’s IT department to quickly resolve issues and prevent downtime.

The log management system 102 may be, for example, a cloud-native log management and analytics platform, such as Logscale, that helps an organization’s IT department collect, search, and analyze log data from its applications and infrastructure. Such a log management system 102 can provide powerful search and filtering capabilities, allowing an IT department to quickly identify and troubleshoot problems. It can also include advanced analytics features, such as machine learning, to help an IT department gain insights into your log data.

The change intelligence system 104 may be a change intelligence platform that helps an IT department understand the impact of changes on the IT environment, such as Evolven, by tracking changes to applications, infrastructure, and configuration, and providing insights into how these changes affect performance and reliability. Such a change intelligence system can help an IT department identify and mitigate risks associated with changes, and improve the overall stability of IT systems 10.

Each of the application monitoring system 100, the log management system 102 and the change intelligence system 104 are complex software systems that run on servers. Each system may have an agent, such as the monitoring agent 110, log management agent 112, and change intelligence agent 114 shown in FIG. 1. The respective agents 110, 112, 114 can be software components that are installed on their corresponding system 100, 102, 104, such as being installed on a server, application server, or network device thereof, to collect specific data.

The agents 110, 112, 114 may write data from their operation to a database(s) 122. In various embodiments, one or more engines 14 may evaluate status-related data from the agents 110, 112, 114 stored in the database 122 to assess whether the agents 110, 112, 114 are working properly. For example, for a Dynatrace application monitoring system 100, the monitoring agent 110 may be a “OneAgent” that collects performance metrics, logs, and other relevant data from various components of the organization’s IT infrastructure. The engine(s) 14 can monitor, for example, the times that the monitoring agent 110 wrote updated monitoring data to the database 122, the times that the log management agent 112 wrote repository log data to the database 122, and times of server status updates for the change intelligence agent 114.

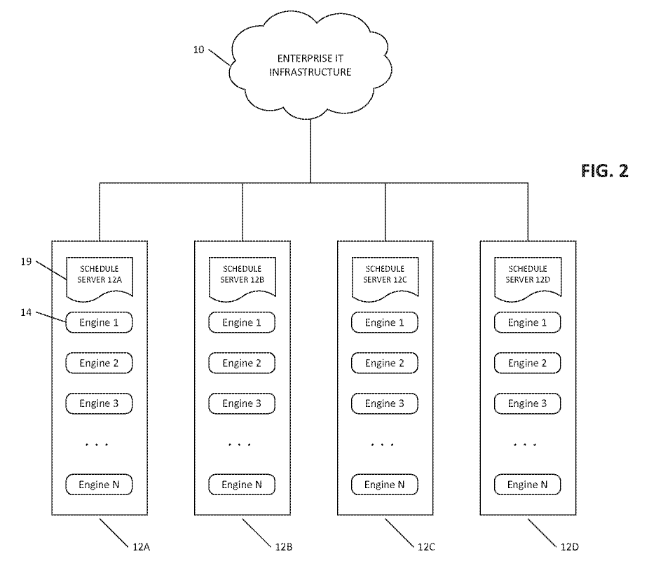

Before explaining the agent monitoring and ticket interruption processes in more detail, a description of an exemplary engine(s) 14 is first provided. The engine 14 may comprise one of multiple engines that could be assigned from time to time to monitor the agents 110, 112, 114 for compliance. FIG. 2 is a diagram showing such engines 14, which are in communication with the organization’s IT infrastructure 10, which can include systems and platforms such as the application monitoring system 100, the log management system 102 and the change intelligence system 104. FIG. 2 shows the engines 14 being run across multiple servers, in this example, four servers 12A-D. Each server 12A-D includes multiple engines 14. Of course, the servers 12A-D can be considered part of the enterprise’s IT infrastructure 10. Each engine 14 is for performing a job that has one or more sequential steps or tasks. There is a script for each job, such as a Python script or a PowerShell script, for example, and execution of job’s script by an engine 14 requires the engine 14 to execute, for example, a job or action with respect to the IT system of the enterprise, such as performing an API call, collecting files from an IT resource, collecting data from a certain IT resource that satisfy specified criteria, etc. One of the tasks that the engines 14 can perform, when scheduled to do so, is monitor the agents 110, 112, 114.

The multiple servers 12A-D could be distributed across multiple data centers, such as two or more data centers. In the illustrated embodiment, the servers 12A-D all contain the same number (N) of engines 14, although in other embodiments, the servers 12A-D do not need have identical numbers of engines 14. Each of the engines 14 is preferably single threaded so that an engine 14 executes one sequence of operations (or thread) at a time. For example, in such a single-thread engine embodiment, each engine 14 handles only one task, request, or connection at any given moment, processing tasks sequentially rather than concurrently.

The engines 14 can be implemented as sets of instructions that run on the servers’ hardware to execute the scripts for the jobs. Each server 12A-D preferably comprises one or more processors for executing the engines 14, along with memory and storage for storing the scripts that are executed by the engines 14. Each of the processors may comprise multiple cores, such as 8, 16 or 20 processor cores, for example. In some embodiments, each server 12A-D comprises at least as many processor cores as there are engines 14 on the server 12A-D, although that is not a requirement and the server’s operating system could use time-sharing or context-switching so that the single-threaded engines can take turns running on the available cores. The servers’ computer memories (e.g., RAM) can store the scripts and the data that the engines 14 operate on during execution. When a script is loaded and run, the data it processes (like variables, datasets, or objects) can be held in RAM. If multiple scripts or processes run concurrently, each can have its own portion of memory. The scripts, along with any libraries and dependencies, can be stored on the servers’ hard drive or SSD. Such storage can also be used to maintain logs, databases, or other persistent data that the engines 14 might access or generate.

The jobs that the engines 14 are to perform may be on a periodic schedule. And different jobs can have different periods depending on the nature of the job. For example, jobs could be scheduled to run every 5, 10, 20, 60, 240, 720, or 1440 minutes, etc., depending on the nature, sensitivity and/or complexity of the job. Some jobs could even have longer or different periods, such as several days. A task scheduling server (not shown) may coordinate and determine the schedules for the servers 12A-D based on parameters for the jobs and based on the number of engines 14 on the servers 12A-D. For example, the task scheduling server can receive values for relevant parameters for each job to be performed by the engines 14. The parameters can include, for example, how often the job is to be run (i.e., its period), how long the job is expected to take for an engine 14 to perform, a spread quantifiers (e.g., standard deviation or variance) on the time needed for the job, a no-earlier-than time to start the job on a given day (e.g., 8:00 am), a no-later-than time to start a job on a given day (e.g., 10:00 pm), etc. Based on the parameter values of the various jobs and other factors, such as the number of engines 14 on the servers 12A-D, the task scheduling server computes and distributes a schedule 19 for each of the servers 12A-D. The servers’ schedules are ordinarily different because, as described above, they preferably are not scheduled to perform the same jobs at the same time.

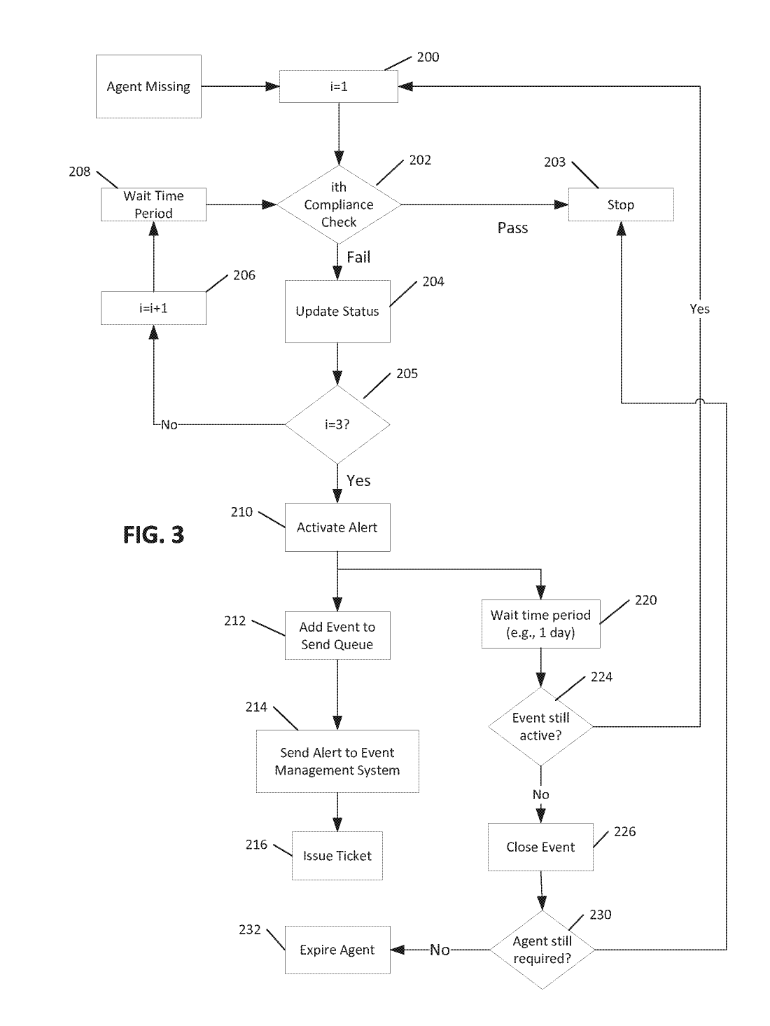

FIG. 3 is a diagram of a process that an engine 14 can perform according to various embodiments of the present invention to monitor the status of the agents 110, 112, 114. One engine 14 could perform the process for one of the agents 110, 112, 114 or different engines 14 could perform the process for respective agents 110, 112, 144. The process of FIG. 3 is described for the sake of example in the context of monitoring the monitoring agent 110 without loss of generality. The process depicted in FIG. 3 can be instituted when the engine 14 finds that an agent, e.g., the monitoring agent 110, is missing. That is, for example, the monitoring agent 110 has not written data to the database 122 in a certain time period, based on, for example, the timestamp of the last time the agent 110 updated information to the database 122. If the last time that the agent 110 updated information to the database 112 was more than a predetermined number of minutes ago, the agent 110 can be considered missing. When an agent is missing, the engine 14 can, at block 200, initialize a counter “i” for the process, such as to set the counter to 1. As will be apparent, the counter tracks how many times the agent is checked before an alert is issued.

At step 202 the engine 14 performs the ith compliance check of the agent 110. Such a compliance check can involve, for example, verifying the connectivity status of the agent 110 and/or verifying its health. The connectivity status check can check whether the agent is sending and receiving data, which can be verified by checking logs and/or monitoring network traffic, for example. The health status of the agent 110 can be verified, for example, based on the agent’s response.

If the agent is functioning at step 202, the process can stop (block 203) because the agent is no longer missing. If the agent fails the ith compliance check at block 202, the processes advances to step 204, where the engine 14 updates, in a log, the status of the monitoring of the missing agent. The first time through the loop, when i=1, at step 204 the current monitoring check can be inserted into the log and the log entry for the newly inserted log can show that the agent. Subsequent trips through the loop can indicate the status of the monitoring of the agent, such as the number of times the agent was checked at step 202, the time since the last check, etc. The log entries can also have numbered rules, such as X0N, where X can be, for example, 1, 2 or 3, where X=1 corresponds to a check of the monitoring agent, X=2 corresponds to a check of the log management system 112, and X=3 corresponds to a check of the change intelligence system 114, and so on for other agents to be monitored. “N” can be an integer that indicates the status of the agent monitoring, such as the number of times through the loop, whether an alert has been issued, etc.

Next, the engine 14 checks the value of the counter at block 205. In the illustrated embodiment, if the counter is less than three (or some other predetermined whole number that specifies how many compliance checks are to be performed at step 202 before sending an alert), then at block 206 the engine 14 can increment the counter by one and then, at step 208, the engine 14 waits a time period before performing the loop of steps 202 to 205 again. The time period waited at step 208 could be the same for each value of “i”, such as 50 minutes or some other suitable and reasonable period of time, or the wait time period could vary based on the value of “i”, e.g., be directly or inversely proportional to the value of “i.” In various embodiments, the loops of steps 202 to 205 are performed at scheduled intervals.

Going back to step 205, if the counter is equal to three, then, in the illustrated embodiment, at block 210 the engine 14 can activate an alert for the agent 110. The log can also be updated with a numbered rule (e.g., X03) corresponding to the activation of the alert.

Two sub-processes can be kicked off from activation of the alert at step 210. One sub-process is that the event can then be added to a messaging queue at step 212 for transmission of the alert. And then, at step 214 the alert can be sent to an event management system 130 of the enterprise. In some embodiments, the enterprise might have multiple event management systems and the alert can be sent to the appropriate one, which can depend on the nature, incident priority rating, and/or type of the alert. All of the prior log entries/rules from the prior steps (e.g., from steps 204) can be included in the alert so that the alert captures information from the prior iterations of the monitoring. Further, at step 216 an ITSM system 132 (which can be integrated with the event management system) of the enterprise (such as Service Now) can issue a ticket for the missing agent.

The other sub-process kicked off at step 210 is to continue monitoring the agent even through the alert was activated and the ticket issued. At step 220, a time period is waited (e.g., 24 hours since activation of the alert) before, at step 224, whether the alert is still active. This can involve, for example, checking the event management system 130 to determine if the event is still active. If the event is still active, the process can return to step 200 for the monitoring process to be repeated. If the event is no longer active at step 224, then the event can be closed at step 226. Then at step 230, the engine 14 can determine if the agent is still required. An agent might no longer be required if, for example, the server on which the agent was running was retired. If the agent is no longer required, the agent can be expired at step 230. And if the agent is still required, the process is over and is performed again the next time the agent (or another one) becomes missing.

In other embodiments, more or fewer than three loops through steps 202 to 205 can be used (e.g., the test for “i” at step 205 could be different than three). Also, the different weight time periods may be used at step 208 for different values of the counter.

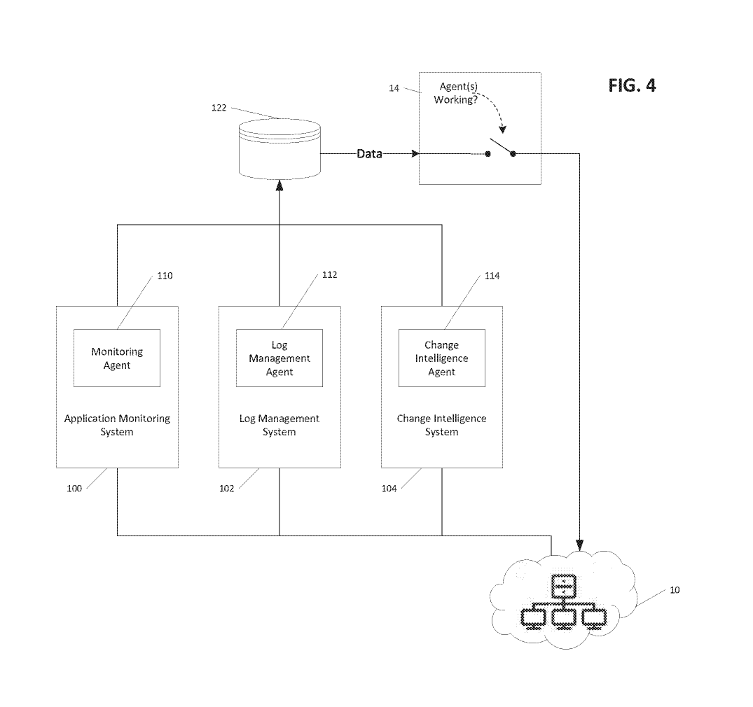

FIG. 4 illustrates a variation of the process. If one of the systems 100, 102, 104 is not functioning properly, it could be causing issues for downstream systems that consume data from any of the systems 100, 102, 104. The issues with the downstream system (shown as part of the enterprise’s IT system 10 in Figure) caused by the upstream system 100, 102, and/or 104 might cause tickets, and possibly numerous tickets, to be generated for the downstream system by the ITSM system 132 when the problem is with the upstream system. To avoid these excessive downstream system tickets, an engine 14 or other job can monitor the status of the systems 100, 102, 104 and their corresponding agents 110, 112, 114, such as by tracking the timestamps of when the agents 110, 112, 114 wrote data to the database 122. If the time is too long, e.g., greater than a threshold, since the timestamp of the last data update from one of the agents, the agent can be considered inoperative and the engine 14 can correspondingly block data from the agent from being sent to the downstream system. Effectively, the engine 14 could open a switch from the database 122 to the downstream system, which interrupts the data as illustrated in FIG. 4. The data transmitted to the downstream system 10 is shown in FIG. 4 as being first written to the database 122 that the engine 14 monitors to track the status of the agents. However, it should be recognized that the engine could block or interrupt the data flow from other sources even though the engine 14 monitors the database 122 to track the status of the agents.

If the engine 14 determines that one of the agents is inoperative, in addition to blocking the data flow from the agent, the engine 14 can activate an alert for the agent. Once the agent becomes operative again, the engine 14 can effectively close the switch so that the data can be transmitted to the downstream system(s) that consume data from the agent. This process can prevent excessive ticket generation for the downstream system(s) that consume data from the agent. Such downstream systems may include, without limitation, ticketing platforms that consume status data to create incidents, event-management systems that correlate agent output with other telemetry, operational dashboards that render real-time health indicators, or automation engines that initiate corrective actions based on incoming metrics. Because these systems consume the data produced by the agents to drive their logic, they may otherwise generate false alarms or initiate unnecessary workflows when an upstream agent becomes inoperative.

The engines 14 may be a daemon or software process implemented as sets of instructions that run on the servers’ hardware to execute the scripts for the jobs. The software for the engines 14 may use any suitable computer programming language such as Java, Python, PowerShell, Ruby, C#, or C++, for example, using conventional, functional, or object-oriented techniques. Programming languages for computer software and other computer-implemented instructions may be translated into machine language by a compiler or an assembler before execution and/or may be translated directly at run time by an interpreter.

The agents 110, 112, 114 may write a status record to a monitored table or message queue. The status record may include, for example, the agent ID, the timestamp when the status record is written, and status-related data. In various embodiments, the engine 14 may query the monitored table or message queue to obtain information from the agents 110, 112, 114. For example, the engine 14 may determine inactivity of the agent by reading the timestamp from when one of the agents 110, 112, 114 last updated the status record and comparing the timestamp with the system clock. If one of the agents 110, 112, 114 has not updated the status record within a predetermined time threshold, that agent may be classified as inoperative. In various embodiments, the predetermined time threshold, number of unsuccessful agent checks, and other relevant parameters can be stored in a configuration file or database table and may be adjusted by an administrator. In addition to using timestamps or status-record updates, various embodiments may employ alternative or supplemental detection mechanisms to determine whether an IT services agent is inoperative. For example, the engine may evaluate heartbeat messages transmitted by the agent at defined intervals, poll an agent-exposed health-check API, monitor error-rate thresholds or anomaly patterns in the data produced by the agent, or analyze network-layer indicators such as connection failures or repeated timeouts. Any one or more of these signals may be used individually or in combination with timestamp analysis to classify an agent as inoperative. These alternative detection techniques allow the system to identify failures even in cases where the agent is still writing limited or stale data, thereby improving the reliability and responsiveness of the monitoring process.

The engine 14 may interrupt data from being shared from the database 122 to the downstream system 10 through various techniques. For example, the engine 14 may set a suspend flag by updating a specific field in the database 122. The engine 14 may also pause the message queue from the agents 110, 112, 114. The engine 14 may also disable the network connection or API connection between the database and the downstream system 10. Once the inoperative agent begins to operate again and updates the status record or passes a compliance check, the engine 14 may clear the suspend flag or reopen the channel to restore communications between the database 122 and the downstream system 10.

In various embodiments, the servers 12A-D could be parts of on-premises networks of the organization and/or cloud networks. The servers 12A-D can be containerized servers or non-containerized (e.g., bare-metal or traditional) servers. A containerized server is essentially a virtualized environment that packages an application and its dependencies together into a single unit, known as a container. This container can be run on any system that supports the containerization technology (e.g., Docker, Kubernetes). Non-containerized servers are physical machines that run a complete operating system and all necessary applications. The components may communicate over standard network protocols such as, TCP/IP or HTTPS, for example.

In one general aspect, therefore, the present invention is directed to computer systems and computer-implemented methods for monitoring information technology (IT) services within an organization’s IT infrastructure. In various embodiments, the method comprises the step of monitoring, by an engine executing on a server of the organization’s IT infrastructure, data written to a database of the organization’s IT infrastructure by an IT services agent of an IT service of the organization’s IT infrastructure. The IT service comprises an IT operations analytics system of the organization’s IT infrastructure. The method further comprises the step of determining, by the engine, that the IT services agent is inoperative based on an absence, within a predefined time interval, of data written to the database by the IT services agent. The method further comprises the step of, upon determining that the IT services agent is inoperative, performing, by the engine, a series of compliance checks of the IT services agent at scheduled intervals, and generating an alert when a predetermined number of failed checks has occurred. And the method further comprises the step of, in response to the alert, automatically interrupting, by the engine, data communications from the database to a downstream system of the organization’s IT infrastructure that consumes data from the IT service agent.

A system according to an embodiment of the present invention comprises a plurality of servers, where each server has one or more engines for performing tasks and an IT services agent which provides an IT operations analytics system of the organization’s IT infrastructure. The system also comprises a database in communication with a downstream system of the IT infrastructure and the plurality of servers, where the database stores data from the IT services agent. The one or more engines execute on a respective one of the plurality servers. And the one or more engines are configured to: monitor data written to the database by the IT services agent; determine that the IT services agent is inoperative based on an absence, within a predefined time interval, of data written to the database by the IT services agent; upon a determination that the IT services agent is inoperative, perform a series of compliance checks of the IT services agent at scheduled intervals, and generate an alert when a predetermined number of failed checks has occurred; and in response to the alert, automatically interrupt data communications from the database to a downstream system of the organization’s IT infrastructure that consumes data from the IT service agent.

In various implementations, the IT operations analytics system comprises an application monitoring system, a log management system, or a change intelligence system.

In various implementations, upon a determination that the IT services agent has regained operation, the engine can automatically restore data communication from the database to the downstream system of the organization’s IT infrastructure.

In various implementations, the engine determines the IT services agent is inoperative by comparing a system time with a timestamp associated with the data most recently written to the database of the organization’s IT infrastructure by the IT services agent.

In various implementations, the alert is sent to an event management system of the IT infrastructure.

In various implementations, the engine continues to monitor the IT services agent after generating the alert.

In various implementations, a plurality of engines perform the steps of the computer-implemented, and the plurality of engines are single-threaded engines and are configured to perform only one job at a time.

In various implementations, the method further comprises the step of expiring, by the engine, an IT services agent that is no longer required.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A computer-implemented method for monitoring information technology (IT) services within an organization’s IT infrastructure, the method comprising:
monitoring, by an engine executing on a server of the organization’s IT infrastructure, data written to a database of the organization’s IT infrastructure by an IT services agent of an IT service of the organization’s IT infrastructure, the IT service comprising an IT operations analytics system of the organization’s IT infrastructure;
determining, by the engine, that the IT services agent is inoperative based on an absence, within a predefined time interval, of data written to the database by the IT services agent;
upon determining that the IT services agent is inoperative, performing, by the engine, a series of compliance checks of the IT services agent at scheduled intervals, and generating an alert when a predetermined number of failed checks has occurred; and
in response to the alert, automatically interrupting, by the engine, data communications from the database to a downstream system of the organization’s IT infrastructure that consumes data from the IT service agent.

2. The computer-implemented method of claim 1, wherein the IT operations analytics system comprises an application monitoring system.

3. The computer-implemented method of claim 1, wherein the IT operations analytics system comprises a log management system.

4. The computer-implemented method of claim 1, wherein the IT operations analytics system comprises a change intelligence system.

5. The computer-implemented method of claim 1, further comprising upon determining that the IT services agent has regained operation, automatically restoring, by the engine, data communication from the database to the downstream system of the organization’s IT infrastructure.

6. The computer-implemented method of claim 1, wherein the engine determines the IT services agent is inoperative by comparing a system time with a timestamp associated with the data most recently written to the database of the organization’s IT infrastructure by the IT services agent.

7. The computer-implemented method of claim 1, wherein the alert is sent to an event management system of the IT infrastructure.

8. The computer-implemented method of claim 1, wherein the engine continues to monitor the IT services agent after generating the alert.

9. The computer-implemented method of claim 1, wherein:
a plurality of engines execute on a respective plurality of servers;
the plurality of engines perform the steps of the computer-implemented method; and
the plurality of engines are single-threaded engines and are configured to perform only one job at a time.

10. The computer-implemented method of claim 1, further comprising expiring, by the engine, an IT services agent that is no longer required.

11. A system for monitoring information technology (IT) services within an organization’s IT infrastructure, the system comprising:
a plurality of servers, each server having one or more engines for performing tasks and an IT services agent which provides an IT operations analytics system of the organization’s IT infrastructure; and
a database in communication with a downstream system of the IT infrastructure and the plurality of servers, wherein the database stores data from the IT services agent;
wherein the one or more engines execute on a respective one of the plurality servers, and wherein the one or more engines are configured to:
monitor data written to the database by the IT services agent;
determine that the IT services agent is inoperative based on an absence, within a predefined time interval, of data written to the database by the IT services agent;
upon a determination that the IT services agent is inoperative, perform a series of compliance checks of the IT services agent at scheduled intervals, and generate an alert when a predetermined number of failed checks has occurred; and
in response to the alert, automatically interrupt data communications from the database to a downstream system of the organization’s IT infrastructure that consumes data from the IT service agent.

12. The system of claim 11 wherein the IT operations analytics system comprises an application monitoring system.

13. The system of claim 11 wherein the IT operations analytics system comprises a log management system.

14. The system of claim 11 wherein the IT operations analytics system comprises a change intelligence system.

15. The system of claim 11, wherein the one or more engines, upon determining that the IT services agent has regained operation, automatically restore data communication from the database to the downstream system.

16. The system of claim 11, wherein the one or more engines determine the IT services agent is inoperative by comparing a system time with a timestamp associated with the data most recently written to the database by the IT services agent.

17. The system of claim 11, wherein the alert is sent to an event management system of the IT infrastructure.

18. The system of claim 11, wherein the engine continues to monitor the IT service agent after generating the alert.

19. The system of claim 11, wherein the one or more engines are single-threaded and configured to perform only one job at a time.

20. The system of claim 11, wherein the one or more engines are configured to expire an IT services agent that is no longer required.
